(19) United States
(12) Patent Application Publication
(10) Pub. No.: US 2025/0278082 A1
(43) Pub. Date: Sep. 4, 2025

(54) NATURAL GAS LIQUIDS QUALITY DIGITALIZED ANALYTICS AND PREDICTIVE SOLUTION

(71) Applicant: Saudi Arabian Oil Company, Dhahran (SA)

(72) Inventors: Mohammed Yousef Saati, Al-Khobar (SA); Mohammad Al Boobaid, Dammam (SA); Meshal Al-Harbi, Dammam (SA); Eid Al-Helal, Dammam (SA); Taib Abang, Dhahran (SA); Alya Al-Musabbeh, Dhahran (SA)

(21) Appl. No.: 18/591,254

(22) Filed: Feb. 29, 2024

(51) Int. Cl. G05B 23/02

(52) U.S. Cl. CPC G05B 23/0275; G05B 23/027

(57) ABSTRACT

A Natural Gas Liquids (NGL) quality digitalized analytics and predictive solution computer-implemented method includes extracting, automatically and in real-time as measured data from elements of a natural gas liquids (NGL) network, values for operating parameters and quality parameters. The measured data is compared against maximum limits. If the comparison indicates the measured data is within limit: 1) normal operations continue and 2) performance is reported. If the comparison is not within limit: 1) an alert notification is issued; 2) an investigation is conducted via trending and root-cause analysis; and 3) corrective and mitigation actions are performed.

### BACKGROUND

Natural Gas Liquids (NGL) systems involve multiple entities, including, for example, producers, intermediate plants, and consumers. Without an ability to monitor and predict critical quality performance parameters in real-time with respect to the multiple entities, efficiency, and performance in the NGL systems can be less than optimal and effect an ability to proactively take corrective actions.

### SUMMARY

The present disclosure describes a Natural Gas Liquids (NGL) quality digitalized analytics and predictive solution.

In an implementation, a computer-implemented method, comprises: extracting, automatically and in real-time as measured data from elements of a natural gas liquids (NGL) network, values for operating parameters and quality parameters; comparing the measured data against maximum limits; if the comparison indicated the measured data is within limit: continuing normal operations; and reporting performance; and if the comparison is not within limit: issuing an alert notification; conducting an investigation via trending and root-cause analysis; and performing corrective and mitigation actions.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach permits using a graphical user interface dashboard to monitor and predict critical quality performance parameters in real-time with respect to, for example, producers, intermediate plants, and consumers. Second, efficiency and performance in the NGL systems can be optimized. Third, through available analytics capability, immediate actions can be taken by appropriate parties to ensure good performance is achieved on a continuous basis. Fourth, the described approach provides a visualization(s) that can show entire systems with color coding (e.g., green, yellow, and red) to indicate that a facility is complying (green), on alert/warning (yellow), and in violation (red). Fifth, notifications generated by the approach can be configured to send messages (e.g., through email or text messages—such as short message service (SMS), multimedia messaging service (MMS), and rich communication services (RCS)) to service, maintenance, and emergency (SME) groups due to an on off-specification determination for any product quality issue in NGL production. Sixth, the described approach can be used to predict an impact of a quality deficiency from producing facilities on receiving facilities and to send predictive alerts on the predicted impact and time of the impact. The predictive data provides the receiving facilities necessary time to take corrective actions, if appropriate.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flowchart illustrating an example of a computer-implemented method for developing a Natural Gas Liquids (NGL) quality digitalized analytics and predictive solution, according to an implementation of the present disclosure.

FIG. 2 is a flowchart illustrating an example of a computer-implemented method for a NGL quality digitalized analytics and predictive solution, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

FIG. 4 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes a Natural Gas Liquids (NGL) quality digitalized analytics and predictive solution and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

NGL systems involve multiple entities, including producers, intermediate plants, and consumers. Without an ability to monitor/predict critical quality performance parameters in real-time with respect to the multiple entities, efficiency, and performance in the NGL systems can be less than optimal and effect an ability to take corrective actions.

The NGL quality digitalized analytics and predictive solution provides digitalized analytics and prediction of NGL and gas condensate quality and overall NGL network quality. The described approach is a digitalized analytics and prediction solution that enables monitoring of real-time data for critical quality performance parameters, such as carbon dioxide (CO₂), hydrogen sulfide (H₂S), and moisture for entire ethane (C₂)+NGL, propane (C₃)+NGL and gas condensate systems. The digitalized solution through the analytics features permits immediate/proactive actions to be taken by appropriate parties to ensure NGL and gas condensate quality requirements are achieved on a continuous basis. In addition, the described approach, through its predicative capability can predict the impact of a quality deficiency on receiving facilities and send predictive alerts on a predicted impact and time of the predictive impact which provides necessary time to take corrective actions, if appropriate.

The solution includes a computer graphical user interface (GUI) dashboard to permit monitoring real-time data for critical quality performance parameters. In some implementations, the approach includes all producers and intermediate plants that produce C2+NGL, C3+NGL, and gas condensate feed streams. Customers of these feed streams, such as NGL fractionation plants, can also be included. Performance can be reported on a regular basis (e.g., weekly or monthly) to all affected parties.

In some implementations, the provided dashboard visualization can show an entire NGL network system with color coding (e.g., green, yellow, and red) to indicate whether a facility is complying (e.g., green), on alert/warning (e.g., yellow), and in violation (e.g., red). Moreover, notifications can be configured to send messages (e.g., through email or text messages-such as short message service (SMS), multimedia messaging service (MMS), and rich communication services (RCS)) to service, maintenance, and emergency (SME) groups due to an on off-specification determination for any product quality issue in NGL production.

In some implementations, the described approach can be used to predict an impact of a quality deficiency from producing facilities on receiving facilities and to proactively send predictive alerts on the predicted impact and time of the impact. The predictive data provides the receiving facilities needed time to take corrective actions, if appropriate. For example, corrective actions can include preparedness of a methanol injection to counter detected high-level of moisture or a blending of liquified ethane or rejection into an ethane reservoir in the event of a detected high-level of H₂S and CO₂. As another example, off-specification products (e.g., CO₂ in ethane and water in Gas Condensate), fouling of heat exchangers (e.g., pre-heaters, reboilers, and condensers), and environmental incompliance (e.g., flaring due to presence of light hydrocarbons on stabilized NGL streams) can be detected and mitigated.

The described real-time approach is dynamic, robust, and expandable (e.g., for new facilities/systems) in high-complexity networks with multiple facilities. The approach covers a wide range of oil & gas production activities from upstream, through midstream, and all the way to downstream facilities.

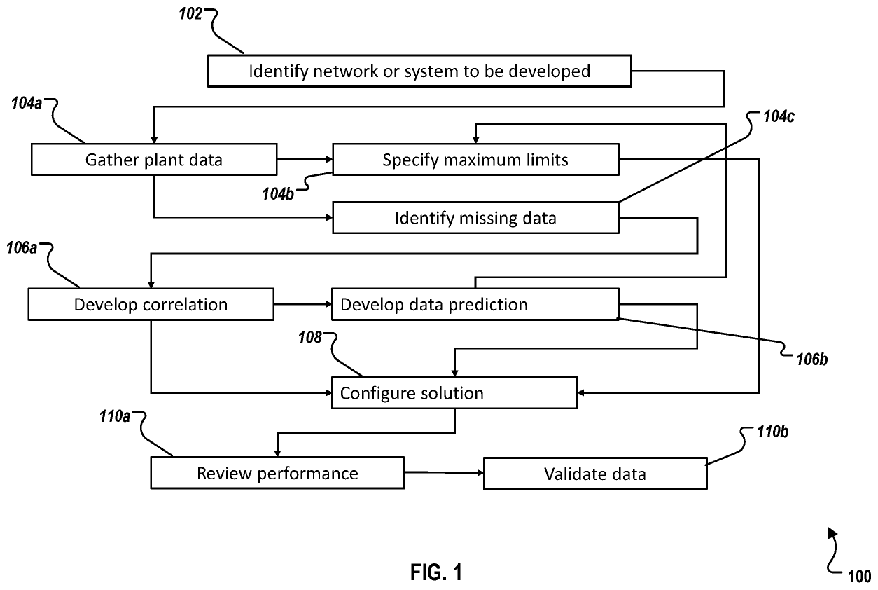

FIG. 1 is a flowchart illustrating an example of a computer-implemented method 100 for developing a Natural Gas Liquids (NGL) quality digitalized analytics and predictive solution, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

### Network/System Identification

At 102, a network or system to be developed and included in the described approach is identified. For example, networks/systems can include C2+NGL, C3+NGL, gas condensate, or others consistent with this disclosure. Identification also includes producers and receiver facilities for each network/system.

A block diagram is developed for each network. In some implementations, the block diagram can include producers and receivers and link producers to receivers.

Block Flow Diagrams (BFDs) are also developed. In some implementations Process Flow Diagrams (PFDs) are used to develop the BFDs. The PFDs are used to develop BFDs for receivers.

From 102, method 100 proceeds to 104a.

### Data Gathering and Specifications

In data gathering and specifications, key process quality parameters are identified. In some implementations and for example, key operating parameters can include flowrate, pressure, temperature, level, and valve opening. Similarly, quality parameters can include moisture, H₂S, CO₂, basic sediment & water (BS&W), salt, methane, and ethane.

Input data is also reviewed and validated in data gathering and specifications. For example, PFD, piping & instrumentation diagram (P&ID), and equipment data sheets can be reviewed for facilities.

At 104a, plant data is gathered. For example, a facility design/operating envelope can be identified. Identifying a facility design/operating envelope can include specifying maximum limits for all operating parameters (e.g., flowrate, pressure, temperature, level, and valve opening) and maximum limits for each quality parameter (e.g., moisture, H₂S, CO₂, BS&W, salt, methane, and ethane).

From 104a, method 100 proceeds to 104b.

At 104b, plant data is gathered. The established maximum limits for operating parameters and quality parameters are used. As an example, in some implementations:
Use design PFD value of the facilities for operating parameters (e.g., flowrate, pressure, and temperature) maximum limits.
Optimize operating range for level at 30-70%.
Optimize operating range for valve opening at 30-70%.
Use external production specification for CO₂ to define maximum limits for CO₂ at 750 ppm in a NGL product at producing facilities by applying a mass balance approach.
Use external production specification for H₂S to define maximum limits for H₂S at 300 ppm in a NGL product at producing facilities by applying a mass balance approach.
Provide operational margin to H₂S where the limit is set at 30 ppm in a NGL product.
Use external production specification for moisture to define maximum limits for moisture at 30 ppm in a NGL product at producing facilities by applying a mass balance approach.
Provide an operational margin to moisture, where the limit is set at 20 ppm in a NGL product.
Use external production specification for BS&W to define maximum limits for BS&W at 0.5 vol % in gas condensate producing facilities.
Provide an operational margin to BS&W where the limit is set at 0.2 vol % in gas condensate.
Use external production specification for BS&W to define maximum limits for salt content at 10 pounds of salt per thousand barrels (PTB) in gas condensate producing facilities.
Review design and operating envelope of receiver facilities to identify maximum limits at producer facilities.
Use computerized process simulation techniques (e.g., ASPEN HYSYS) to obtain hydrate formation in deethanizer column overhead to determine a maximum limit of moisture in a C2+NGL feed at 50 ppm.

Additionally, in some implementations, plant information (PI) tags (e.g., used by AVEVA PI System software) can be identified for producers and receivers. PI tags can be identified for operating parameters (e.g., flowrate, pressure, temperature, level, and valve opening) and for online analyzing equipment (e.g., moisture, H₂S, CO₂, BS&W, salt, methane, and ethane). In some implementations, self-correcting features include using alternative values (such as, default values or different tags) if a tag shows no data value (e.g., due to a server or other error).

From 104b, method 100 proceeds to 104c.

At 104c, missing data is identified. For example, and in some implementations, missing data/parameters can be identified. Missing data/parameters can include missing data for operating parameters and missing data for quality parameters.

From 104c, method 100 proceeds to 106a.

### Correlation and Prediction Development

In correlation and prediction development, adjacent instruments (e.g., located upstream or downstream) are used to supply missing operating parameters within the facilities (e.g., flowrate, pressure, and temperature). Mass balance can be used to obtain a single flowrate value from facilities by summing flowrates from multiple trains that are equipped with individual flowmeters.

In some implementations, if no online analyzers are available to determine quality parameters (e.g., moisture, H₂S, CO₂, BS&W, salt, methane, and ethane), an approach can be to: 1) use laboratory analysis from a laboratory information management system (LIMS), where PI tags are configured for each quality parameter, lab results are mapped from LIMS into each PI tag, and data is read from the PI tags and 2) correlation is used from available online analyzers (e.g., located upstream or downstream) within the facilities.

At 106a, correlations are developed.

In some implementations, correlations are developed for quality parameters (e.g., H₂S, CO₂, moisture, methane, and Ethane) in a NGL product based on upstream on-line analyzers. For example, in some implementations:
Identify available online analyzers located at upstream processing units.
Develop a process simulation for the processing units.
Simulate at least 5 scenarios in the process simulator that varies quality parameters (e.g., H₂S, CO₂, moisture, methane, and ethane) content at a location of available online analyzers.
Record in a graph for quality parameters (e.g., H₂S, CO₂, moisture, methane, and ethane) content at the online analyzers versus values in a NGL product.
Plot the graph for all points to obtain an equation to correlate between the online analyzer with the quality parameters (e.g., H₂S, CO₂, moisture, methane, and ethane) content in the NGL product.
Create PI tags that capture the value for the quality parameters (e.g., H₂S, CO₂, moisture, methane, and ethane) by applying the developed equation to the measured value from the online analyzers.

In some implementations, correlation is developed for quality parameters (H₂S, CO₂, moisture, methane, and ethane) in a NGL product based on stripper column bottom temperature. For example, in some implementations:
Develop a process simulation for a stripper column system.
Simulate at least 5 scenarios in the process simulator that varies the stripper column bottom temperature.
Record in a graph for stripper column bottom temperature versus quality parameters (e.g., H₂S, CO₂, moisture, methane, and ethane) in a NGL product.
Plot the graph for all points to obtain an equation to correlate stripper column bottom temperature with quality parameters (e.g., H₂S, CO₂, moisture, methane, and ethane) in the NGL product.
Create PI tags that capture a value for the quality parameters (e.g., H₂S, CO₂, moisture, methane, and ethane) by applying the developed equation to stripper column bottom temperature.

From 106a, method 100 proceeds to 106b.

At 106b, data predictions are developed.

In some implementations, predictive correlation is developed for various operating and quality parameters. For example, in some implementations:
Tray stripper/stabilizer column temperature is used to predict light components in bottom product.
Water interface level is used to predict BS&W and salt carryover at downstream facilities.
On-line analyzers are used in ethane products for H₂S, CO₂ and moisture to predict quality parameters in the NGL feed.
Valve opening of sour gas from amine unit at propane treatment unit and mass balance from a process simulation is used to predict an amount of H₂S in the NGL feed stream.
Steam consumption at reboilers is used to predict solid loading in the NGL feed.
Mass balance approach is applied for all correlations involving various trains/modules and multiple producer and receiver facilities.

In some implementations, solid loading index correlation for reboiler maintenance prediction includes:
Obtaining heat exchanger design parameters.
Identifying operating parameters upstream and downstream of heat exchanger (e.g., process flowrate, steam flowrate, and inlet & outlet temperature).
Linking actual operating parameters and applying mass balance to calculate an actual heat exchanger overall heat transfer coefficient.
Comparing the calculated solid loading index versus design.
Developing a graph showing the trend of heat exchanger actual performance over time.
Identifying a date when the reboiler requires maintenance (i.e., when a trend crosses a maximum limit).

In some implementations, establishing a prediction on quality parameters at receiving facilities includes:
Obtaining flowrate from all producing facilities.
Obtaining pipeline physical parameters (e.g., diameter and length) from producing facilities to receiving facilities.
Calculating fluid velocity for all pipeline sections from producers to receiver.
Using a mass balance approach to predict an arrival time of any occurrence of upset/off-specification events at any producing facilities.

From 106b, method 100 proceeds to 108.

### Solution Configuration

At 108, a solution is configured.

In some implementations, the solution can include using an asset framework (e.g., OSISOFT ASSET FRAMEWORK software). An asset tree of the solution can be developed. In an example, the asset tree can connect to multiple PI computer servers (e.g., 20 servers), the asset tree can contain 3 levels, and PI tags can be mapped (e.g., 1500+ PI tags).

In some implementations, a template of the solution can be created for scalability. For example, common attributes can be defined, units of measurement can be configured, common correlations can be identified, and common alert notifications can be identified. The use of the template can permit simple expansion to include new facilities.

In some implementations, correlations can be created. For example, formulas can be configured in the asset framework and calculated results can be stored in the PI tags.

In some implementations, alert notifications can be configured. For example, which scenarios will trigger an alert notification include specifying trigger values, off-specification duration, and alert issuance frequency; email format can include a described upset scenario, off-specification limit specification, off-specification duration specification, facility specification, impacted receiving facility identification, registration of a time when an off-specification event occurred, providing a link to access the solution, providing an expected arrival at receiving facilities, providing corrective actions by producing and receiving facilities, and providing a contact engineer email address for further clarification.

In some implementations, the describe solution can create email that is either common or specific, configure a recipient of an alert using group emails or an individual email, create an escalation email to a higher authority if a problem continues, configure an alert to specific groups for each facility (e.g., producer, receiver, and central organizations), and temporarily disable alert notifications during plant shutdowns (e.g., maintenance or Turnaround & Inspection (T&I)) to avoid false alarms.

In some implementation, a web-based user GUI can be developed with a visualization software (e.g., using OSISOFT PI) for the described approach. For example, and in some implementations:
A level 1 page can be created for the main page that illustrates all facilities. The GUI can include a map with all operating facilities, display production/supply routes, and include a table with a corporate informational summary.
A level 2 page can be created for a facility, where the level 2 includes a block diagram and a table that summarizes key perfomance of the facility.
A level 3 page can be created for a stream, where the level 3 includes a created template display and a table presenting stream key performance data.
Data sources can be displayed (e.g., from P=PI, L=LIMS, or C=Correlation).
A color code can be configured based on measured values, where the color code is activated for a stream line and also in displayed texts/boxes. For example, in an implementation, green can represent normal/on-specification, red can represent off-specification, and gray can represent no/bad data.
Data trends can be configured.

In some implementations, calculations can be created to display a realized cost benefit, efficiency improvement, or other value consistent with this disclosure. For example, displayed values could include steam consumption reduction, methanol injection reduction, lower reboiler cleaning, lower product giveaway, and any other cost saving or cost avoidance due to improved feed quality parameters.

In some implementation, a report can be extracted from the link provided to access the solution.

From 108, method 100 proceeds to 110a.

### Performance Review and Data Validation

At 110a, performance is reviewed, including review of data. In some implementations, review of data includes review of operating parameters and quality parameters, corrective actions for any errors, validation with actual facility performance, verification of instrument functionality, and tracking of all corrective actions from maintenance records.

From 110a, method 100 proceeds to 110b.

At 110b, data is validated. In some implementations, data validation includes verification of calculated quality parameters (e.g., check healthiness of PI tag data, check against independent parameters, check against lab analysis, and check against process simulation), deployment of the solution on a trial basis (e.g., obtain feedback from facilities, and perform correction/obtain re-confirmation), updating the solution (e.g., including new facilities or trains/modules, removing facilities that no longer are in service, modifying a configuration to reflect changes in a facility, and modifying limits for a new design upgrade implemented at a facility), and full deployment at an entity level (e.g., starting online monitoring, providing technical support for corrective actions when alert notifications are triggered, using data from the solution to issue periodic quality performance reports).

After 110b, method 100 can stop.

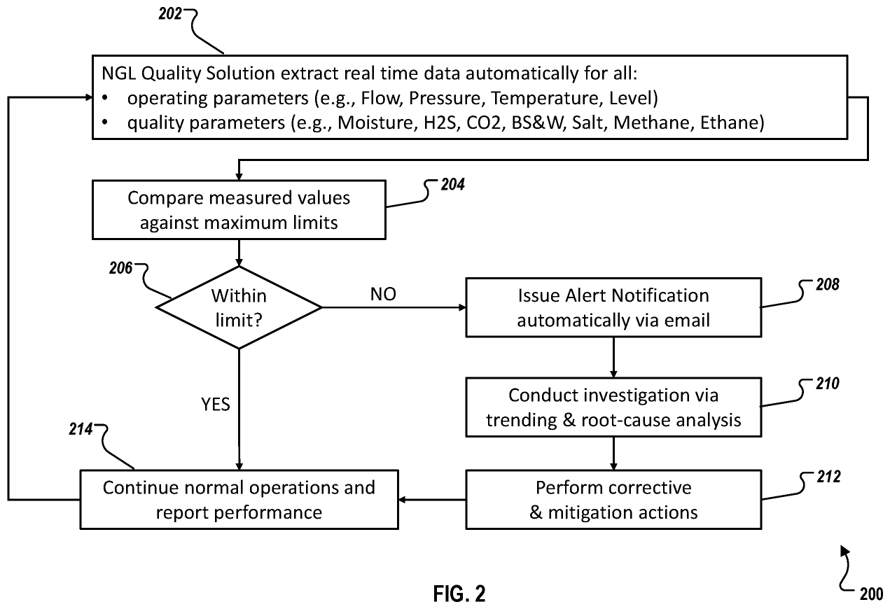

FIG. 2 is a flowchart illustrating an example of a computer-implemented method 100 for a Natural Gas Liquids (NGL) quality digitalized analytics and predictive solution, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 202, the described solution extracts real-time data automatically from elements of a NGL network. For example, data can be extracted for operating parameters (e.g., flow, pressure, temperature, and level) and quality parameters (e.g., moisture, H₂S, CO₂, BS&W, salt, methane, and ethane). From 202, method 200 proceeds to 204.

At 204, measured values are compared against determined maximum limits. From 204, method 200 proceeds to 206.

At 206, a determination is made as to whether the comparison is within limit. If it is determined that the comparison is within limit, method 200 proceeds to 214. Otherwise, if it is determined that the comparison is not within limit, method 200 proceeds to 208.

At 214, normal operations continue, and performance is reported. From 214, method 200 proceeds back to 202.

At 208, an alert notification is issued automatically via email. In some implementations, alerts can be issued alternatively by or in combination with a text message (e.g., SMS, MMS, or RCS). In some implementations, notifications can be configured to only be issued when operating facilities are in service, meaning defined conditions will prevent issuance of alerts of off-specification product or process parameters when associated facilities are non-operational.

From 208, method 200 proceeds to 210.

At 210, an investigation via trending and root-cause analysis is conducted. In some implementations, the investigation is conducted manually by industry experts. The provided data by the described solution allows the industry experts to focus on specific facilities and parameters to expedite finding real root-causes and quickly mitigate issues. In some implementations, software algorithms (e.g., artificial intelligence) can be used to perform the trending/root-cause analysis.

From 210, method 200 proceeds to 212.

At 212, based on the results of the investigation of 210, corrective and mitigation actions are performed. The corrective actions identified as part of the investigation findings can be used to update/enhance the described solution. For example, a target value can be adjusted to an appropriate level based on the investigation findings.

Corrective actions depend on the root-cause of the quality incompliance. For example, if the quality issue is related to high water in the NGL product, then the corrective action is to ensure the water interface level is properly controlled. A generated alert can provide an advisory on an appropriate corrective action. In some implementations, the described solution can automatically initiate corrective actions (e.g., increasing operating temperature so that the column will produce an on-specification product, opening valves, increasing pressure, and methanol injection).

From 212, method 200 proceeds to 214.

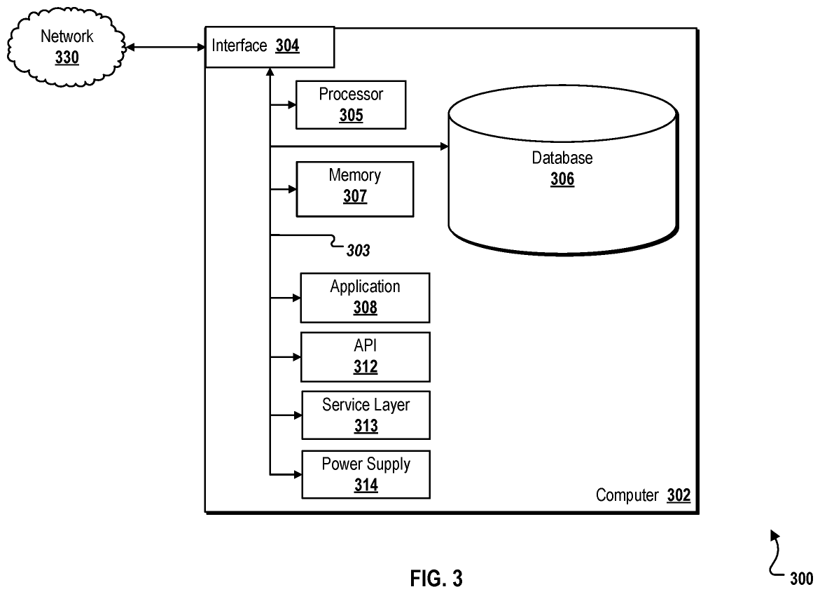

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, computer-implemented system 300 includes a Computer 302 and a Network 330.

The illustrated Computer 302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 302 can include an input device, such as a keypad, keyboard, or touch screen, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as, for example, a client, network component, a server, or a database or another persistency, or a combination of roles for performing the subject matter described in the present disclosure. The illustrated Computer 302 is communicably coupled with a Network 330. In some implementations, one or more components of the Computer 302 can be configured to operate within an environment, or a combination of environments, including cloud-computing, local, or global.

At a high level, the Computer 302 is an electronic computing device operable to receive, transmit, process, store, or manage data and information associated with the described subject matter. According to some implementations, the Computer 302 can also include or be communicably coupled with a server, such as an application server, e-mail server, web server, caching server, or streaming data server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory or conventional database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302. The Database 306 can hold and operate on at least any data type mentioned or any data type consistent with this disclosure.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

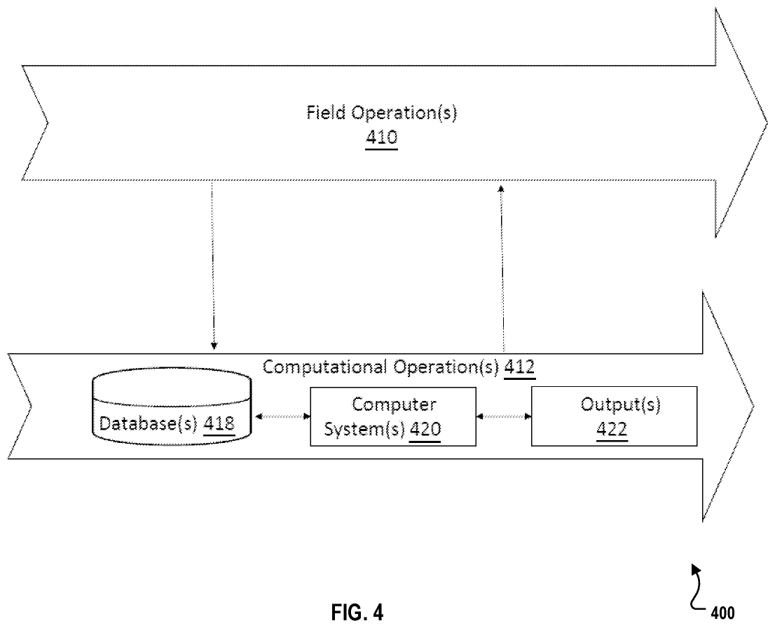

FIG. 4 illustrates hydrocarbon production operations 400 that include both one or more field operations 410 and one or more computational operations 412, which exchange information and control exploration for the production of hydrocarbons, according to an implementation of the present disclosure. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively, or in addition, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a computer-implemented method, comprising: extracting, automatically and in real-time as measured data from elements of a natural gas liquids (NGL) network, values for operating parameters and quality parameters; comparing the measured data against maximum limits; if the comparison indicated the measured data is within limit: continuing normal operations; and reporting performance; and if the comparison is not within limit: issuing an alert notification; conducting an investigation via trending and root-cause analysis; and performing corrective and mitigation actions.

The foregoing and other described implementations can each, optionally, include one or more of the following features:

A first feature, combinable with any of the following features, wherein the operating parameters include flow, pressure, temperature, and level and quality parameters include moisture, H2S, CO2, BS&W, salt, methane, and ethane.

A second feature, combinable with any of the previous or following features, wherein the alert notification includes email or text messages, wherein the text messages include short message service (SMS), multimedia messaging service (MMS), and rich communication services (RCS).

A third feature, combinable with any of the previous or following features, wherein the investigation via trending and root-cause analysis is performed by an artificial intelligence algorithm.

A fourth feature, combinable with any of the previous or following features, comprising providing an advisory with the alert notification, wherein the advisory provides a proposed corrective action.

A fifth feature, combinable with any of the previous or following features, wherein performing corrective and mitigation actions are automatically performed by software algorithms.

A sixth feature, combinable with any of the previous or following features, wherein corrective and mitigation actions include increasing operating temperature, opening valves, increasing pressure, and methanol injection.

In a second implementation, a non-transitory, computer-readable medium storing one or more instructions executable by a computer system to perform one or more operations, comprising: extracting, automatically and in real-time as measured data from elements of a natural gas liquids (NGL) network, values for operating parameters and quality parameters; comparing the measured data against maximum limits; if the comparison indicated the measured data is within limit: continuing normal operations; and reporting performance; and if the comparison is not within limit: issuing an alert notification; conducting an investigation via trending and root-cause analysis; and performing corrective and mitigation actions.

The foregoing and other described implementations can each, optionally, include one or more of the following features:

A first feature, combinable with any of the following features, wherein the operating parameters include flow, pressure, temperature, and level and quality parameters include moisture, H2S, CO2, BS&W, salt, methane, and ethane.

A second feature, combinable with any of the previous or following features, wherein the alert notification includes email or text messages, wherein the text messages include short message service (SMS), multimedia messaging service (MMS), and rich communication services (RCS).

A third feature, combinable with any of the previous or following features, wherein the investigation via trending and root-cause analysis is performed by an artificial intelligence algorithm.

A fourth feature, combinable with any of the previous or following features, comprising providing an advisory with the alert notification, wherein the advisory provides a proposed corrective action.

A fifth feature, combinable with any of the previous or following features, wherein performing corrective and mitigation actions are automatically performed by software algorithms.

A sixth feature, combinable with any of the previous or following features, wherein corrective and mitigation actions include increasing operating temperature, opening valves, increasing pressure, and methanol injection.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: extracting, automatically and in real-time as measured data from elements of a natural gas liquids (NGL) network, values for operating parameters and quality parameters; comparing the measured data against maximum limits; if the comparison indicated the measured data is within limit: continuing normal operations; and reporting performance; and if the comparison is not within limit: issuing an alert notification; conducting an investigation via trending and root-cause analysis; and performing corrective and mitigation actions.

The foregoing and other described implementations can each, optionally, include one or more of the following features:

A first feature, combinable with any of the following features, wherein the operating parameters include flow, pressure, temperature, and level and quality parameters include moisture, H2S, CO2, BS&W, salt, methane, and ethane.

A second feature, combinable with any of the previous or following features, wherein the alert notification includes email or text messages, wherein the text messages include short message service (SMS), multimedia messaging service (MMS), and rich communication services (RCS).

A third feature, combinable with any of the previous or following features, wherein the investigation via trending and root-cause analysis is performed by an artificial intelligence algorithm.

A fourth feature, combinable with any of the previous or following features, comprising providing an advisory with the alert notification, wherein the advisory provides a proposed corrective action.

A fifth feature, combinable with any of the previous or following features, wherein performing corrective and mitigation actions are automatically performed by software algorithms.

A sixth feature, combinable with any of the previous or following features, wherein corrective and mitigation actions include increasing operating temperature, opening valves, increasing pressure, and methanol injection.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
extracting, automatically and in real-time as measured data from elements of a natural gas liquids (NGL) network, values for operating parameters and quality parameters;
comparing the measured data against maximum limits;
if the comparison indicated the measured data is within limit:
continuing normal operations; and
reporting performance; and
if the comparison is not within limit:
issuing an alert notification;
conducting an investigation via trending and root-cause analysis; and
performing corrective and mitigation actions.

2. The computer-implemented method of claim 1, wherein the operating parameters include flow, pressure, temperature, and level and quality parameters include moisture, H2S, CO2, BS&W, salt, methane, and ethane.

3. The computer-implemented method of claim 1, wherein the alert notification includes email or text messages, wherein the text messages include short message service (SMS), multimedia messaging service (MMS), and rich communication services (RCS).

4. The computer-implemented method of claim 1, wherein the investigation via trending and root-cause analysis is performed by an artificial intelligence algorithm.

5. The computer-implemented method of claim 1, comprising providing an advisory with the alert notification, wherein the advisory provides a proposed corrective action.

6. The computer-implemented method of claim 1, wherein performing corrective and mitigation actions are automatically performed by software algorithms.

7. The computer-implemented method of claim 1, wherein corrective and mitigation actions include increasing operating temperature, opening valves, increasing pressure, and methanol injection.

8. A non-transitory, computer-readable medium storing one or more instructions executable by a computer system to perform one or more operations, comprising:
extracting, automatically and in real-time as measured data from elements of a natural gas liquids (NGL) network, values for operating parameters and quality parameters;
comparing the measured data against maximum limits;
if the comparison indicated the measured data is within limit:
continuing normal operations; and
reporting performance; and
if the comparison is not within limit:
issuing an alert notification;
conducting an investigation via trending and root-cause analysis; and
performing corrective and mitigation actions.

9. The non-transitory, computer-readable medium of claim 8, wherein the operating parameters include flow, pressure, temperature, and level and quality parameters include moisture, H2S, CO2, BS&W, salt, methane, and ethane.

10. The non-transitory, computer-readable medium of claim 8, wherein the alert notification includes email or text messages, wherein the text messages include short message service (SMS), multimedia messaging service (MMS), and rich communication services (RCS).

11. The non-transitory, computer-readable medium of claim 8, wherein the investigation via trending and root-cause analysis is performed by an artificial intelligence algorithm.

12. The non-transitory, computer-readable medium of claim 8, comprising providing an advisory with the alert notification, wherein the advisory provides a proposed corrective action.

13. The non-transitory, computer-readable medium of claim 8, wherein performing corrective and mitigation actions are automatically performed by software algorithms.

14. The non-transitory, computer-readable medium of claim 8, wherein corrective and mitigation actions include increasing operating temperature, opening valves, increasing pressure, and methanol injection.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
extracting, automatically and in real-time as measured data from elements of a natural gas liquids (NGL) network, values for operating parameters and quality parameters;
comparing the measured data against maximum limits;
if the comparison indicated the measured data is within limit:
continuing normal operations; and
reporting performance; and
if the comparison is not within limit:
issuing an alert notification;
conducting an investigation via trending and root-cause analysis; and
performing corrective and mitigation actions.

16. The computer-implemented system of claim 15, wherein the operating parameters include flow, pressure, temperature, and level and quality parameters include moisture, H2S, CO2, BS&W, salt, methane, and ethane.

17. The computer-implemented system of claim 15, wherein the alert notification includes email or text messages, wherein the text messages include short message service (SMS), multimedia messaging service (MMS), and rich communication services (RCS).

18. The computer-implemented system of claim 15, wherein the investigation via trending and root-cause analysis is performed by an artificial intelligence algorithm.

19. The computer-implemented system of claim 15, comprising providing an advisory with the alert notification, wherein the advisory provides a proposed corrective action.

20. The computer-implemented system of claim 15, wherein performing corrective and mitigation actions are automatically performed by software algorithms.
